(19) United States
(12) Patent Application Publication
(10) Pub. No.: US 2013/0178996 A1
(43) Pub. Date: Jul. 11, 2013

(54) INTELLIGENT POWER SUPPLY SYSTEM AND DEVICE HAVING WIRELESS IDENTIFICATION

(71) Applicants: Max Li, Dana Point, CA (US); Roy Ting, New Taipei City (TW)

(72) Inventors: Max Li, Dana Point, CA (US); Roy Ting, New Taipei City (TW)

(21) Appl. No.: 13/371,475

(22) Filed: Feb. 13, 2012

(30) Foreign Application Priority Data
Jan. 9, 2012 (TW) 101200500

(51) Int. Cl. G06F 1/26

(52) U.S. Cl. 700/295

(57) ABSTRACT

An intelligent power supply system having wireless identification employ an RFID wireless identification technique in collaboration with multiple intelligent receptacles respectively equipped with multiple intelligent chip modules mounted in multiple power sockets of the receptacles to precisely locate each electric appliance within a region and power consumption information of the electric appliance. The collected product and power consumption information is transmitted to a remote site for instant monitoring and control through a network, thereby facilitating the management of power utilization efficiency of equipment inside a region and reducing the severe equipment damage and data loss caused by abrupt power outage, including regular power supply detection and allocation, automatic power-off protection upon power irregularity, early notice of obsolete parts.

### FIELD OF THE INVENTION

The present invention relates to an intelligent power supply system and device having wireless identification and more particularly to an intelligent receptacle using an RFID wireless identification technique in collaboration with an intelligent chip module to collect and transmit related information through a network to a remote monitoring and control center, thereby precisely locating irregular wiring and power supply conditions, facilitating wire and equipment maintenance, and effectively obtaining power efficiency of equipment in a region on a real-time basis.

### BACKGROUND OF THE INVENTION

New generation intelligent receptacles having intelligent chip modules are used to detect the power consumption of multiple electric appliances connected therewith. When any of the electric appliances undergoes an irregular power supply condition and is automatically powered off, power consumed in a region where the electric appliances are located can be digitally managed to make power allocation more flexible and safe and achieve energy economy targets and power-savings effects. Despite fulfillment of switch control and power management objectives, conventional intelligent receptacles are unable to identify the electric appliances plugged therein. Hence, when each electric appliance is connected with another receptacle or is changed to another operating environment, setting up the electric appliance once again gives rise to inconvenience in terms of equipment management. In fact, the feature of purely controlling and limiting power supply of the receptacle is not enough to effectively keep track of actual power consumption of all electric appliances in an identical power supply region. Incomplete collection of power consumption information is never sufficient to realize remote monitoring and control of power consumption in the region at all times.

Such issues, reflecting on aspects advanced information technology (IT) industries, are aggravating. For example, whether regular large scale keyboard-video-mouse (KVM) switches or the rapidly developing cloud computing in networking applications nowadays, a data center is usually equipped with a tremendous number of servers combined to achieve practical functions as demanded. When taking more compact computer servers but higher computing power and denser power-consuming equipment into account, the required power supply allocation and management is challenging indeed. Besides, to ensure operational stability around the clock, regular data centers plan on and are designed to inevitably consume more power. An electric bill and maintenance charge arising from inefficient power utilization can be staggering and run counter to energy economics concepts.

To keep up with the constant addition of equipment, network complexity and continuous expansion of the network, servers and storage media in data centers cannot help multi-fold growth in terms of quantity. Such expansion oftentimes results in space shortage, multifarious and messy wires and disorderly generatrix in data centers. As all equipment in a data center must be connected with external power sources and densely arranged in the same space, if certain equipment abnormally consumes more power or any obsolete power supply is about to be fail, detecting such a problem beforehand is totally beyond the capabilities of conventional intelligent receptacles. The mentioned problem can only be identified and fixed after its occurrence. Upon identifying and maintaining the wiring problem, service personnel on site need to move out each equipment and check power cables one by one to make sure that power supplied to the equipment therethrough is normal. Besides the time-consuming troubleshooting, the maintenance costs are high and the operational efficiencies are poor. Furthermore, data centers are usually full of hubs ending up with twisted and entangled power cables and network lines all around, which worsen the wire spotting problem and easily trip up passerby to cause power shutdowns and heavy loss of equipment and information.

### SUMMARY OF THE INVENTION

The objective of the present invention is to provide an intelligent power supply system, which employs an RFID wireless identification technique in collaboration with multiple intelligent receptacles respectively equipped with multiple intelligent chip modules mounted in multiple power sockets of the receptacles, to precisely locate each electric appliance within a region and power consumption information of the electric appliance so that the collected product and power consumption information is transmitted to a remote site for instant monitoring and control through a network, thereby facilitating the management of power utilization efficiencies of equipment inside a region and reducing the severity of equipment damage and data loss caused by abrupt power outages, including regular power supply detection and allocation, automatic power-off protection upon power irregularity detection, and early notice of obsolete parts.

The foregoing and other features and advantages of the present invention will be more clearly understood through the following descriptions with reference to the drawing, wherein:

### BRIEF DESCRIPTION OF THE DRAWINGS

FIG. 1 is a schematic view of a layout of an intelligent power supply system in accordance with the present invention;

FIG. 2 is a perspective view of a standalone intelligent power supply device in accordance with the present invention;

FIG. 3 is a schematic view of a layout of the standalone intelligent power supply device in FIG. 2; and

FIG. 4 is a schematic view of an application using the standalone intelligent power supply device in FIG. 2.

### DETAILED DESCRIPTION OF THE PREFERRED EMBODIMENT

It is to be noted that the following descriptions of preferred embodiments of this invention are presented herein for purpose of illustration and description only; it is not intended to be exhaustive or to be limited to the precise form disclosed.

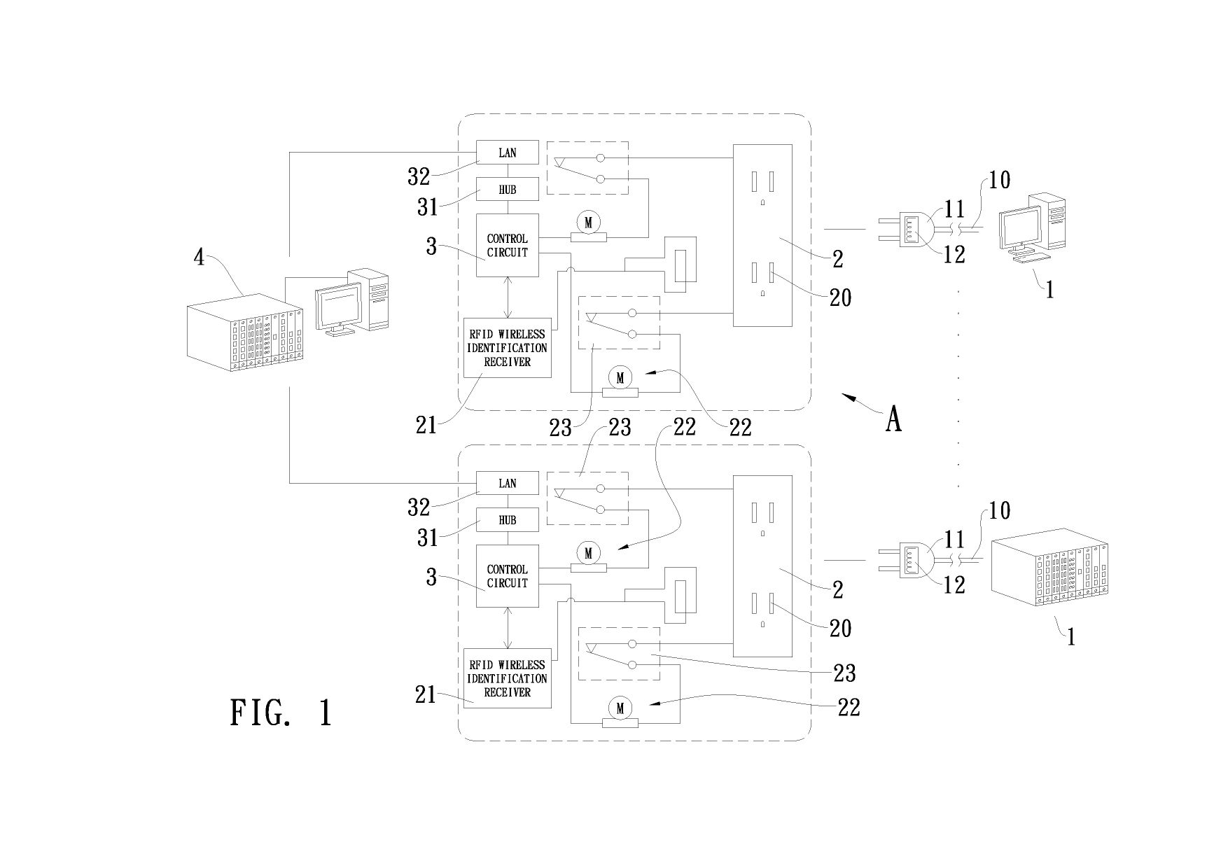

The present invention will now be described more specifically in terms of structure and applications thereof with reference to the following embodiments. With reference to FIG. 1, an intelligent power supply system having wireless identification in accordance with the present invention is mounted within a region A and has at least one electric appliance 1, multiple receptacles 2, multiple control circuits 3 and multiple hubs 31.

Each one of the at least one electric appliance 1 has a power plug 11 and an RFID wireless identification transmitter 12. The RFID wireless identification transmitter 12 is connected to a power supply loop 10 or specifically mounted on the power plug 11 of the electric appliance 1 to wirelessly transmit signals each having an identification number (ID) of the electric appliance 1.

Each receptacle 2 has multiple power sockets 20, an RFID wireless identification receiver 21, multiple power measuring units 22 and multiple power control units 23. The power sockets 20 are formed in the receptacle 2. The RFID wireless identification receiver 21 is mounted on the receptacle 2 to detect the ID of the electric appliance 1. Each power measuring units 22 and one of the power control units 23 are mounted inside one of the power sockets 20.

Each control circuit 3 is connected with the RFID wireless identification receiver 21, the power measuring unit 22 and the power control unit 23 of one of the receptacles 2. Each hub 31 is connected to one of the control circuits 3 and a local area network (LAN) 32 for each control circuit 3 to transmit power information of each one of the at least one electric appliances 1 connected with a corresponding power socket 20 to a remote control center 4 and for the remote control center 4 to selectively switch on or off the at least one electric appliance 1.

Given the intelligent power supply system, product information and power consumption information of each electric appliance 1 connected to a corresponding power socket 20 within the region A can be monitored and powered on or off by a command sent from the remote control center 4 to the power socket 20.

To implement the intelligent power supply system, a wireless transmission technique, such as Zigbee, Z-WAVE, Bluetooth or the like, can be employed. When implemented with Zigbee, a communication protocol defined in certain layer of an interoperable smart energy standard can be configured in a preset user-defined application stack area of an interoperable home automation standard. The intelligent power supply system can be built in compliance with the interoperable home automation standard to measure power consumption measurement, power on or off the electric appliance 1 connected to each controlled power socket 20, and provide a fine-tunable dimmer to control power supplied to the controlled power socket in the region A.

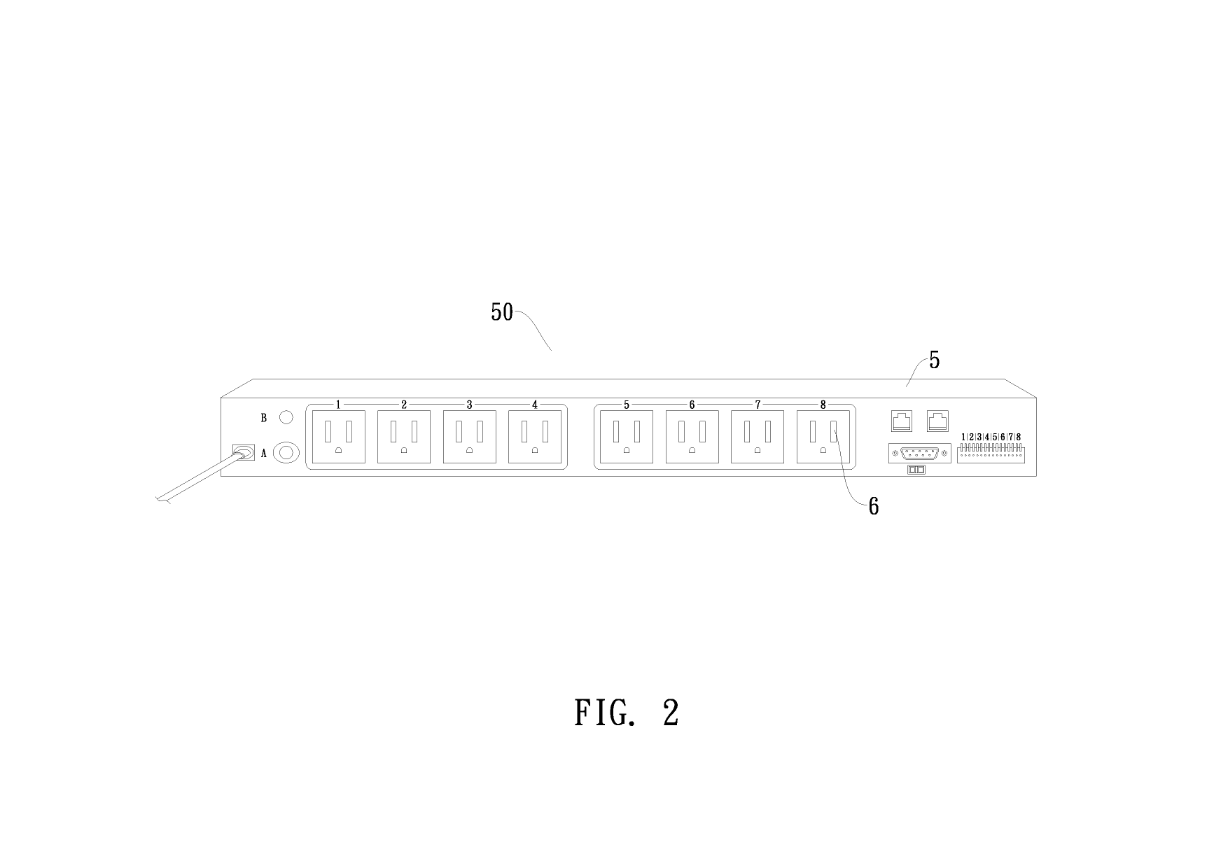

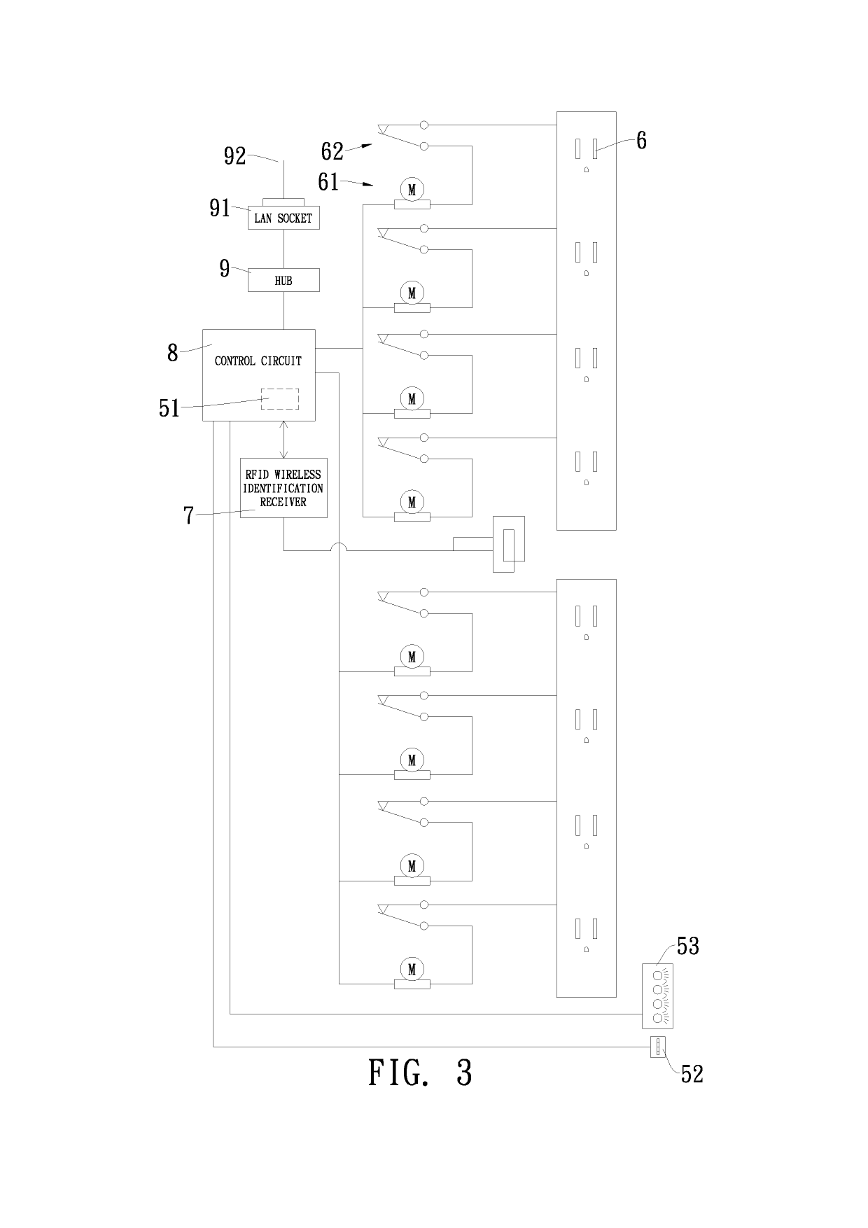

With reference to FIGS. 2 and 3, to meet specific actual demands in daily life, an intelligent power supply device having wireless identification 50 in accordance with the present invention is designed as a standalone unit in compliance with Zigbee and has a flat housing 5, at least one RFID wireless identification receiver 7, a control circuit 8 and a built-in hub 9.

The housing 5 has an internal circuit connected to a power input and multiple power outputs and having a fuse (not shown) and a memory 51. The housing 5 further has multiple power sockets 6, multiple intelligent chip modules (not shown), a USB socket 52 and a set of status indicators 53. The power sockets 6 are formed on a front side of the housing 5. In the present embodiment, the housing 5 has eight power sockets 6 formed thereon. Each intelligent chip module is mounted in one of the power sockets 6 and has a power measuring unit 61 and a power control unit 62. The USB socket 52 is mounted in a periphery of the housing 5 and is hot pluggable. The set of status indicators is mounted on the periphery of the housing 5.

The at least one RFID wireless identification receiver is mounted among the power sockets to detect the ID of each one of the at least one electric appliance connected with a corresponding power socket as shown in FIG. 1.

The control circuit 8 is connected to the at least one RFID wireless identification receiver 7, and the power measuring unit 61 and the power control unit 62 in each power socket 6 to detect and collect the ID and power consumption information of each electric appliance 1 connected to a corresponding power socket 6 and control the power control unit 62 to switch on or off.

The built-in hub 8 is connected to the control circuit 8 to transmit data through a LAN socket 91 of the hub 8 and a network cable 92 connected with the LAN socket 91.

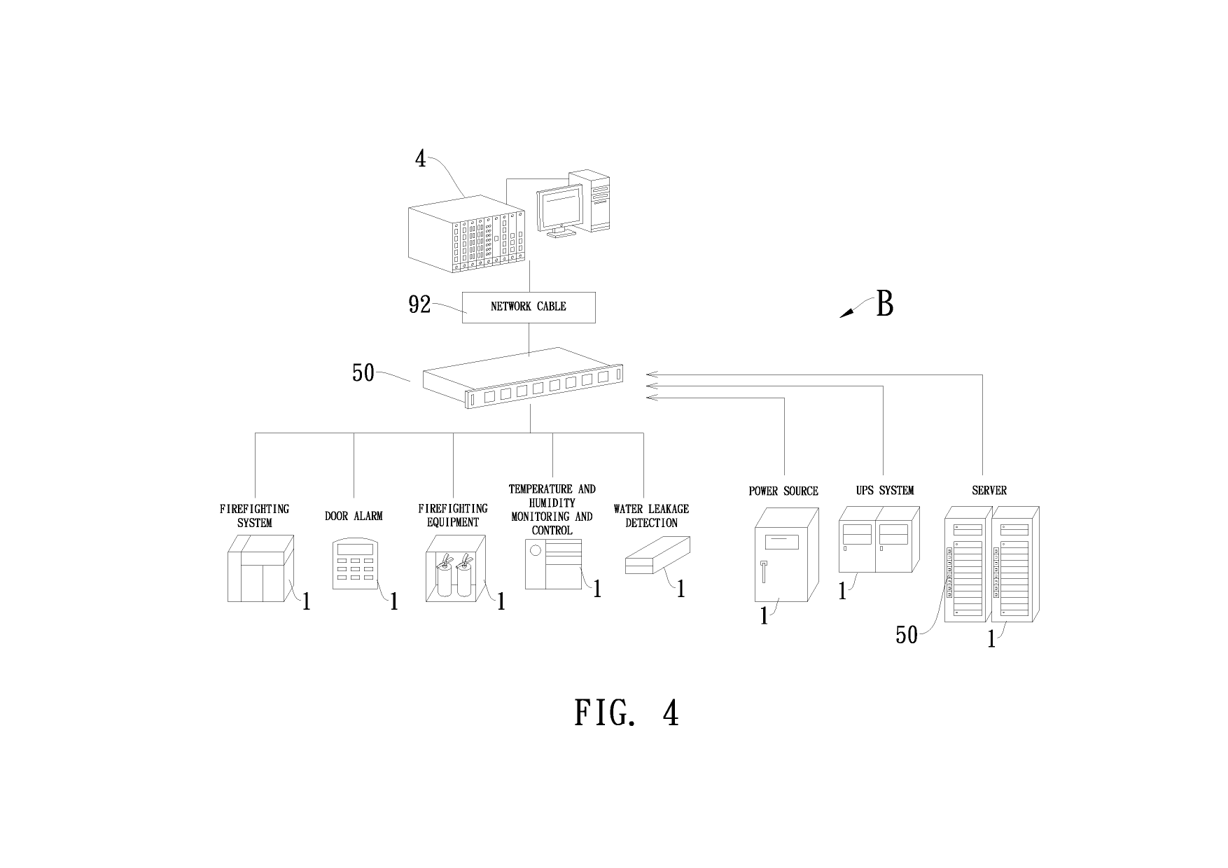

With reference to FIG. 4, the intelligent power supply device 50 in accordance with the present invention is effectively designed to facilitate itself to be conveniently applied to all kinds of large data centers B. Hence, huge amounts of electric appliances 1, such as servers, door alarms, air conditioners, uninterruptible power supplies (UPSs), firefighting equipment and the like, can be orderly arranged and connected to the intelligent power supply devices 50 to collect actual power consumption information of the electric appliances 1 at all times through the control circuit 8 and the hub 9 and transmit the power consumption information to the remote control center 4 through the network cable 92. Therefore, the product information and the power consumption information of the electric appliance 1 connected to each power socket 6 in a corresponding data center can be monitored and controlled. According to actual power consumption information of each electric appliance 1, the remote control center 4 can optimally adjust and allocate the power consumed in the region by remotely powering on off the respective power sockets, thereby effectively managing the utilization efficiency of power consumed in the region. Upon detecting irregular power condition, automatic power-off protection is activated to precisely position and manage the faulty equipment and problem so as to provide timely and accurate processing at site, save time and effort, and achieve efficient operations. Even when there exist aging parts, replacement of them can be anticipated and noticed in advance to maintain overall operational efficiencies of all equipment in a power supply region and reduce the severe equipment damage and information loss caused by a power outage.

Moreover, for an ordinary living or working environment, certain major electric appliances 1 are sometimes concentrated in the living room of a house or a particular space in an office. Whereas there may not be so many power sockets within this particular space, the drawback of failing to fully identifying each electric appliance 1 and the power consumption thereof cannot be ruled out. The standalone intelligent power supply device 50 having wireless identification can thus be employed as a power extension cord for intelligent power supply detection, similarly, the intelligent power supply device 50 is feasible to effectively keep track of actual power supply of each electric appliance 1 within an identical power supply space and collect and record respective and entire power consumption data of all the electric appliances for the management and reference of future power supply.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. An intelligent power supply system having wireless identification and mounted within a region, the system comprising:
at least one electric appliance, each one of the at least one electric appliance having an RFID wireless identification transmitter mounted to a power supply loop of the electric appliance to wirelessly transmit a signal having an identification number of the electric appliance;
multiple receptacles, each receptacle having:
multiple power sockets;
a RFID wireless identification receiver mounted on the receptacle to detect the ID of the electric appliance;
multiple power measuring units respectively mounted inside the power sockets; and
multiple power control units respectively mounted inside the power sockets;
multiple control circuits, each control circuit connected with the RFID wireless identification receiver, the power measuring unit and the power control unit of one of the receptacles; and
multiple hubs, each hub connected to one of the control circuits and adapted to connect to a local area network (LAN) for each control circuit to transmit power information of each one of the at least one electric appliance connected with a corresponding power socket to a remote control center and for the remote control center to selectively switch on or off the at least one electric appliance.

2. The system as claimed in claim 1, wherein
each one of the at least one electric appliance has a power plug; and
the RFID wireless identification transmitter is mounted on the power plug of the electric appliance.

3. The system as claimed in claim 2, wherein the region is a data center.

4. The system as claimed in claim 3, wherein each one of the at least one RFID wireless identification transmitter and each RFID wireless identification receiver are built according to a protocol in compliance with one of Zigbee, Z-WAVE and Bluetooth.

5. The system as claimed in claim 4, wherein each one of the at least one RFID wireless identification transmitter and each RFID wireless identification receiver comply with Zigbee defined in a layer of an interoperable smart energy standard that is configured in a preset user-defined application stack area of an interoperable home automation standard, the system measures power consumption measurement, powers on or off the electric appliance connected to each power socket, and provides a fine-tunable dimmer to control power supplied to the power socket in the region according to the interoperable home automation standard.

6. An intelligent power supply device having wireless identification, comprising:
a housing having:
an internal circuit connected to a power input and multiple power outputs;
multiple power sockets formed on a front side of the housing;
multiple intelligent chip modules, each intelligent chip module mounted in one of the power sockets and having a power measuring unit and a power control unit;
at least one RFID wireless identification receiver mounted among the power sockets and adapted to detect an identification numbers of each one of at least one electric appliance connected to one of the power sockets;
a control circuit connected to the at least one RFID wireless identification receiver, and the power measuring unit and the power control unit in each power socket, adapted to detect and collect the ID and power consumption information of the electric appliance connected to a corresponding power socket and controlling the power control unit to switch on or off; and
a built-in hub connected to the control circuit to transmit data through a LAN socket of the hub and a network cable connected with the LAN socket.

7. The device as claimed in claim 6, wherein
the housing has:
eight power sockets formed thereon;
a USB socket mounted in a periphery of the housing and is hot pluggable; and
a set of status indicators is mounted on the periphery of the housing; and
the internal circuit has a fuse and a memory.

8. The device as claimed in claim 7, wherein each one of the at least one RFID wireless identification receiver is built according to a protocol in compliance with one of Zigbee, Z-WAVE and Bluetooth.

9. The device as claimed in claim 8, wherein each one of the at least one RFID wireless identification receiver complies with Zigbee defined in a layer of an interoperable smart energy standard that is configured in a preset user-defined application stack area of an interoperable home automation standard, the device measures power consumption measurement, powers on or off the electric appliance connected to each power socket, and provides a fine-tunable dimmer to control power supplied to the power socket according to the interoperable home automation standard.
